(19) United States
(12) Patent Application Publication
(10) Pub. No.: US 2008/0073431 A1
(43) Pub. Date: Mar. 27, 2008

(54) SENSOR MONITORING, LOGGING, AND ALERTING VIA DISPLAY ENABLED WIRELESS DEVICES FOR RETAIL APPLICATIONS

(75) Inventor: Jesse Davis, Berkeley, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: W5 Networks, Inc.

(21) Appl. No.: 11/535,059

(22) Filed: Sep. 25, 2006

(51) Int. Cl. G06K 15/00

(52) U.S. Cl. 235/383

(57) ABSTRACT

Systems, apparatus, and methods for utilizing sensors in conjunction with display enabled wireless devices are provided. Wireless devices transmit signals to and receive signals from disconnected systems preferably comprising one or more access points or hand-held devices. The access points and hand-held devices preferably communicate with a server which operates to manage the wireless devices. Optionally, the wireless devices take various actions depending on the values read from their attached sensors. These actions may include initiating a communication, changing a displayed message, or flashing an LED. Optionally, the server receives, stores, recalls, displays, and/or requests sensor readings transmitted by the wireless devices.

### FIELD OF THE INVENTION

The present invention relates to sensor monitoring, logging, and alerting via display enabled wireless devices for retail applications. Display enabled wireless devices used in retail application are often referred to as Electronic Shelf Labels (ESLs).

### BACKGROUND INFORMATION

U.S. Pat. No. 7,095,794 describes an Electronic Shelf Label (ESL) system comprising wireless devices and base stations. The wireless link between ESLs and base stations is specifically described as utilizing Radio Frequency (RF) back scatter on the uplink to the base stations.

U.S. Pat. No. 7,040,536 describes an ESL device itself utilizing a Liquid Crystal Display (LCD) to display messages and prices.

U.S. Pat. No. 7,005,962 describes a price label system comprising a server, transceivers, and price labels. The described system utilizes several communication methods in different sub-cells to communicate with a subset of the price labels within that sub-cell.

U.S. Pat. No. 6,749,116 describes a price display system comprising an electronic display strip comprising non-volatile memory, an electronic display area, and a signaling system, a server, and a hand-held device. The sensor described as a part of the electronic display strip is meant for the sole purpose of receiving signals from a hand-held device which cause prices to move along to specified positions along the display.

U.S. Pat. No. 6,550,673 describes an electronic display system for displaying sales item data on store shelves. The electronic display system comprises electronic display devices and a display bus system attached to the shelves for wired communication to the display devices.

### SUMMARY

An object of the present invention is to provide a wireless device capable of displaying a message or price and employing a sensor or sensor suite to sense its surroundings in a retail environment.

A further object of the present invention is to provide a method for such a wireless device to take actions based on its sensor readings, such as, for example, initiating a communication to another system, changing the message it displays, and/or flashing a Light Emitting Diode (LED).

A further object of the present invention is to provide a system to receive, store, recall, display, and optionally request sensor readings from such wireless devices.

Further objects, aspects, and advantages of the present teachings will be readily understood after reading the following description with reference to the drawings and the appended claims.

### BRIEF DESCRIPTION OF THE DRAWINGS

FIG. 1 shows a block diagram of a representative wireless device with a display and a single sensor according to an embodiment of the invention.

FIG. 2 shows a block diagram of a representative wireless device with a display and a sensor suite according to an embodiment of the invention.

FIG. 3 shows a representative system comprising access points, a server, and/or a hand-held device for wirelessly communicating with a multiplicity of wireless devices according to an embodiment of the invention.

FIG. 4 shows a physical realization of a representative wireless device with a display displaying an example message and light emitting diode according to an embodiment of the invention.

FIG. 5 shows a physical realization of a representative server with attached display showing an example graphical representation of sensor data according to an embodiment of the invention.

### GLOSSARY OF TERMS

The following abbreviations are utilized in the following description, which are intended to have the meanings provided as follows:
ADC—analog to digital converter
AP—access point
CAN—controller area network
ESL—electronic shelf label
HVAC—heating ventilation and air conditioning
IC—integrated circuit
IIC/I2C/I²C—inter-integrated circuit
IR—infra-red
LCD—liquid crystal display
LED—light emitting diode
OLED—organic light emitting diode
RAM—random access memory
RF—radio frequency
Rx—receiver
SPI—serial peripheral interface
Tx—transmitter

### DETAILED DESCRIPTION

Each of the additional features and teachings disclosed below may be utilized separately or in conjunction with other features and teachings to provide improved wireless sensing systems and methods for designing and using the same. Representative examples of the present invention, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detail description may not be necessary to practice the invention in the broadest sense, and are instead taught merely to particularly describe representative examples of the present teachings.

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter.

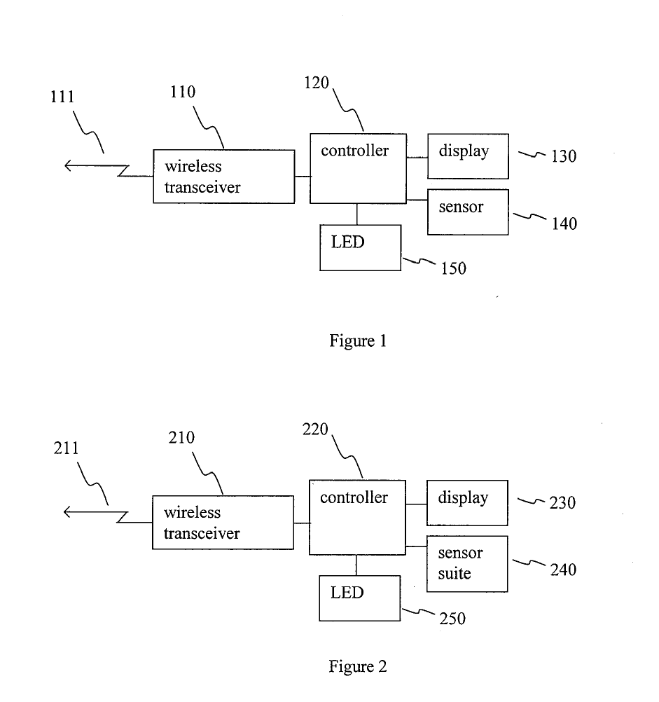

FIG. 1 shows a block diagram of a wireless device 300, 400 according to an embodiment of the invention. The wireless device comprises a wireless transceiver 110, a wireless transceiver physical interface 111, a controller 120, a display 130, a sensor 140, and a Light-Emitting Diode (LED) 150. The wireless transceiver 110 may be implemented by any type of wireless communication device and method either as an integrated or discrete component. Some common wireless communication methods include, but are not limited to, Radio Frequency (RF), Infra-Red (IR), inductive coupling, and ultra-sound. The wireless transceiver physical interface 111 depends on the specific type of wireless transceiver 110 used. Some examples include an antenna for RF, an LED for IR, an antenna coil for inductive coupling, or a speaker for ultra-sound.

The controller 120 in FIG. 1 comprises the circuits and/or code which make up the logical operation and management of the full device. The controller 120 may be static or reconfigurable (e.g. reprogrammable), and incorporates the sensor interface. The controller 120 itself may be either an integrated or discrete component within the wireless device 300, 400, and serves to operate the display 130, wireless transceiver 110, and sensor 140. In one implementation, the controller 120 may gather data from the sensor 140 and take different actions based on the sensor value recorded. These actions may include, for example, changing the message on the display 130, turning on the LED 150 for a set amount of time, intermittently, or continuously, or initiating a communication with a disconnected system (such as an Access Point (AP) 320 or hand-held device 325) via the wireless transceiver 110. The interface on the controller 120 to the sensor 140 depends on the type of sensor attached, but may be via, for example, an Analog-to-Digital Converter (ADC), a Serial Peripheral Interface (SPI) digital bus, an Inter-Integrated Circuit (IIC/I2C/I²C) digital bus, an RS-232 digital bus, or a Controller Area Network (CAN) digital bus.

The display 130 in FIG. 1 can display messages such as prices and/or promotions. The display 130 is an integral part of these devices since the primary purpose they serve is to display information to customers. This display 130 can be based, for example, on Liquid Crystal Displays (LCDs), Organic Light Emitting Diodes (OLEDs), bi-stable display technology, or electronic ink. The display 130 can be segmented or dot-matrix, black and white or color.

The inclusion of the sensor 140 in FIG. 1 is an innovation of the present invention. It will be recognized by those skilled in the art that using wireless displays as a foundation for wireless sensor networks is a new concept in retail applications. Until this innovation, wireless displays, which are also known as Electronic Shelf Labels (ESLs), have not been able to also sense their environment and provide distributed data feedback to environmental control systems and/or store employees. This sensor 140 allows environmental monitoring, logging, and alerting, and allows a host of new potential applications, for example, distributed temperature monitoring, distributed presence detection, and/or distributed noise level monitoring.

An additional innovation of having a sensor 140 in the device is sensor based communication initiation. In one implementation, for example, the device can be configured to initiate a communication session if the sensor data goes over a programmed threshold. It will be recognized by those skilled in the art that current wireless display technologies perform in a polled communication mode where the wireless devices cannot initiate communications—they simply respond to wireless communications initiated by a disconnected system, such as an AP 320 or hand-held device 325. In the present invention, any on-board event, such as sensor data going beyond a threshold or a timer expiring, can cause the device to asynchronously initiate a communication session at any time on or off of a normal periodic cycle.

Lastly, FIG. 1 also shows an LED 150. This LED is operated by the controller to flash with a certain pattern or stay on continuously. In one implementation, it can be used to alert store personnel of a problem with the device, for example. In another implementation, it can be used to draw attention to the device for customers of the store, for example.

FIG. 2 shows a block diagram of a wireless device 300, 400 according to another embodiment. The wireless device comprises a wireless communication interface 210, wireless communication medium 211, a controller 220, a display 230, a sensor suite 240 comprising a multiplicity of sensors, and an LED 250. This device is similar to the device shown in FIG. 1 except that this device has a multiplicity of sensors attached to the controller 220 instead of just one. The operational principles of this device are very similar to those of the device depicted in FIG. 1 except for the control, management, and interaction with the multiplicity of sensors versus the single sensor in FIG. 1. The multiple sensors attached to the device may be of different types from each other and may have different types of interfaces as well. The controller may take actions based on sensor data from the multiple sensors which may be considered independently, all together, or in subsets.

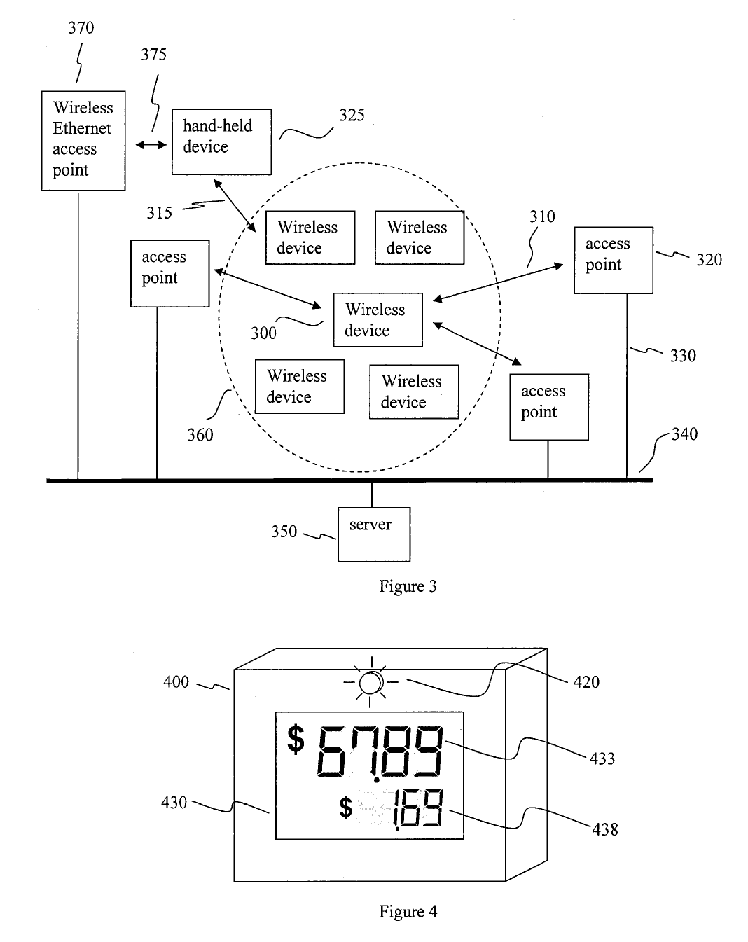

FIG. 3 shows a plurality of these wireless devices 300, 400 used simultaneously in different physical locations to form a distributed network of wireless devices 360. These wireless devices can communicate directly with disconnected devices, such as, for example, an AP 320 over a wireless link 310, or a hand-held device 325 over a wireless link 315. The APs are connected, e.g., via Ethernet 330, to a network 340 with a server 350 to manage them. The hand-held device may optionally also connect to the server 350 network 340 via a wireless Ethernet access point 370 over a wireless link 375.

The sensor 140 or sensor suite 240 readings may be reported to a disconnected system with or without request. In one implementation, a server 350 may be used to log and store the sensor data, and/or to send a message back to the wireless device 300, 400 from which the data came, to another wireless device 300, 400, or to a group of wireless devices. The server 350 may also be operated to transmit or display textual or graphical representations of the sensor data from individual wireless devices 300, 400, or a group of wireless devices.

The server 340 may also track the locations of the individual wireless devices, e.g., within a store. For example, each wireless device may periodically broadcast an RF signal that is received by multiple APs in the distributed network. The distance of the device from each of these APs may then be calculated based on the time delay of the RF signal to each AP. Since the locations of the AP are known, the distance of the device from each AP can be used to triangulate the location of the device, e.g., within the store. Other signals and/or received data can be used to determine location such as received signal strength, proximity detection, angle-of-arrival, time-difference-of-arrival as are well known in the art. Thus, the server 340 can log and store not only the sensor data from a wireless device but also the location of the device, e.g., within the store. In stead of tracking the location of the device, current wireless display technologies depend on a store employee to enter the current location of a device into a database. As a result, current wireless display technologies are prone to error because the device may be placed in the wrong location, or the device may be moved away from its correct location. These problems are avoided by having the distributed network track the real location of the wireless devices. For example, the server may store the location of where a device is suppose to be located and compare this location with the tracked location of the device to determine whether the device is in the correct location. If the device is placed in the wrong location or moved away from its correct location, the server may send a message to a store employee of this fact. The server may also graphically display the locations of the devices within a store by overlaying the tracked locations of the devices onto a graphical representation of the store floor.

The hand-held device 325 is preferably a wireless mobile device that a store employee can carrying around the store to get status and sensor information from individual wireless devices. For example, if the employee wants status and sensor information from a particular wireless device, the employee may send a request for that information from the hand-held device to the wireless device. Upon receiving the request, the wireless device may send the requested information to the hand-held device via its wireless transceiver. The employee may identify the wireless device of interest by, for example, entering an ID for that device into the hand-held device or pointing the hand-held device in the direction of the wireless device. The server may also track the location of the hand-held device 325 within the store using similar methods as those used to track the wireless device, e.g., RF signal triangulation. The server may then send the hand-held device 325 messages of its tracked location. Alternatively or in addition, the hand-held device 325 can determine its location by receiving, e.g., RF signals from access points at known locations, and using the time delay of these RF signals to triangulate its location. The hand-held device may use the location data to display a map showing its location. In one implementation, the hand-held device 325 may direct an employee to a wireless device of interest by displaying a map with directions from the current location of the hand-held device to the wireless device of interest. The hand-held device 325 may also be used by the employee to remotely access the server while on the floor. This way, the hand-held device 325 effectively acts as a “server display to-go” that allows the employee to receive information, e.g., distributed temperature readings, from the server while on the floor, and not just in the back office.

FIG. 4 shows a representative physical realization of a wireless device 300, 400. An LED 420 is shown, and is used as discussed above for the LED 150, 250 in FIG. 1 and FIG. 2. A display 430 is also shown, and is used as discussed above for the display 130, 230 in FIG. 1 and FIG. 2. An example message is displayed on the display 430. The example message includes a price 433 and a per unit price 438 as shown in FIG. 4. The message may also include other information, for example, a description of the corresponding product, promotional information, a club member price, etc. The wireless device may have a mounting mechanism (not shown) on the back for attaching the device to objects, such as, for example, shelves, poles, hooks, display cases, flat surfaces and/or doors.

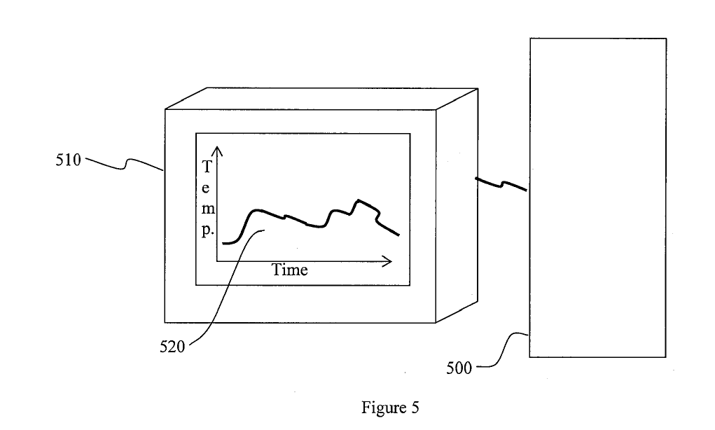

FIG. 5 shows a representative physical realization of a server 500 with an attached display 510, in which the server 500 is causing the display 510 to show an example graphical representation of sensor data 520. There are several other ways that sensor data may be displayed graphically, such as, for example as a geographic overlay of a store layout or in a histogram. The graphical representation of sensor data 520 depicted in FIG. 5 is shown only as an example.

The following several application examples are provided solely to describe potential applications of the system described, and not in any way to limit the scope the invention. In these application examples, the server may use the tracked locations of the devices, e.g., within a store, to determine the locations or areas from which sensor data is taken.

In one implementation, the sensor 140 or sensor suite 240 may comprise, for example, a temperature sensor. A distributed temperature sensor network can be used for a variety of applications including, for example, distributed temperature monitoring, food safety, energy management, and/or feedback data to a Heating, Ventilation, and Air Conditioning (HVAC) system. In this implementation, the display 130, 230 on the wireless device 300, 400 may be operated to display this temperature data so that store employees can read the temperature of any area of the store as they walk through that area. In another implementation, the temperature will not be displayed, but it will be read and monitored by the controller 120, 220. In either of these two implementations, for example, if the temperature goes outside of a programmable guard band, the controller 120, 220 may send a message to the server 350 alerting it of this fact. This may be used, for example, to send an alert when the temperature for refrigerated products falls outside a temperature range needed to maintain food safety. The controller 120, 220 may also change the message on the display 130, 230 to show a warning symbol or warning message. The controller 120, 220 may also cause the attached LED 150, 250 to start flashing. When the server 350 receives the message from the device 300, 400, the server 350 may then be caused to take some further action, such as, for example, display a warning for a store employee, send a signal to an environmental control system, such as, for example, a HVAC system, or send an electronic message to a store manager, such as, for example, a text message to a cellular telephone or an electronic mail. For the example of a HVAC system, the temperature readings may be used to provide the HVAC system with temperature feedback so that the HVAC can adjust heating, ventilation, and/or air conditioning accordingly to maintain a desired temperature.

In another implementation, the sensor 140 or sensor suite 240, may comprise, for example, a motion detection sensor. A distributed motion detection network can be used for a variety of applications including, for example, lighting control, individual wireless device 300, 400 power management, and/or to track occupancy of areas of the store both in real-time and historically. In this implementation, the display 130, 230 on the wireless device 300, 400 may be operated to turn off when no motion is detected for a programmed length of time. The purpose of such an implementation would be to reduce power consumption of the wireless device 300, 400 in order to extend its battery life time. The LED 150, 250 in this implementation may be operated to turn on when motion is detected. The purpose of such an implementation would be to attract attention to the wireless device 300, 400 when someone is present. Regardless of whether the display 130, 230 or LED 150, 250 is turned on and off, the controller 120, 240 may use motion detection to record occupancy statistics, such as, for example, percent of occupancy over a certain time, and send a message to the server 350 periodically with this data. This data may be used, for example, to create a geographic overlay of a store floor plan so that a store manager can determine traffic patterns throughout the store. This information would be useful, for example, when charging product providers for product placement and/or determining what products or types of products attract more attention than others. The data may also be used, for example, by the server 350 to control a store wide lighting system. For example, the lights in areas of the store without any traffic, i.e., without any detected motion, could be turned down or off to conserve electricity.

In another embodiment, the sensor 140 or sensor suite 240, may comprise, for example, a tamper sensor. A distributed tamper detection network can be used for a variety of applications including, for example, theft and loss prevention and/or detection of tampering with individual wireless devices 300, 400. In this implementation, the controller 120, 220 may, for example, cause the wireless device 300, 400 to cease functioning if the tamper sensor remains active for a programmed length of time. The controller 120, 220 may also, for example, turn off the display 130, 230 or show a specific message on the display 130, 230 when the tamper sensor is active. Regardless of the control of the display 130, 230, the wireless device 300, 400 may send a message to the server alerting it that the device 300, 400 has been tampered with. The server may then, for example, display a warning or send a message to a store employee alerting them of the tampering, so that they may prevent theft of the device 300, 400, and/or stop the tampering by reattaching the device 300, 400 to the shelf if it has been removed, or preventing the mechanism of the tampering from occurring.

In another implementation, the sensor 140 or sensor suite 240 may comprise, for example, one or more chemical sensors. In this implementation, a chemical sensor may be used, for example, to monitor produce for spoilage by chemically detecting a programmed level of gases emitted from produce as they spoil. When spoilage is detected, the controller 120, 220 may send a message to the server alerting it of this fact. The server may then send an alert to a store employee so that the spoiled produce can be quickly removed before it adversely affects surrounding produce. For example, it is known that some produce, e.g., apples, emit ethylene gas as they spoil, and that emissions of ethylene gas from one produce item can accelerate spoilage of the surrounding produce items. In this example, a chemical sensor sensitive to ethylene gas may be used to detect the spoilage of produce. The chemical sensor may also be used to detect chemical fumes released by certain products when they break, e.g., container of bleach.

In another implementation, the sensor 140 or sensor suite 240 may comprise, for example a humidity or moisture sensor. In this implementation, a humidity sensor may be used, for example, to monitor the humidity around products that are to be kept within a certain humidity range, e.g., produce. For example, if the humidity goes outside a programmable guard band, the controller 120, 220 may send a message to the server alerting it of this fact.

In another implementation, the sensor 140 or sensor suite 240 may comprise, for example, an acoustic sensor. In this implementation, an acoustic sensor may be used to monitor the noise level. For example, a noisy environment in a shopping area may keep shoppers away from that area. In this example, if the noise level goes above a programmable level for a certain time, the controller 120, 220 may send an alert to the server alerting it of this fact. The server may then send an alert to a store employee so that the employee can investigate the cause of the noise and fix it. For example, in an electronics store, the volume of demo speakers may be set too high. In another implementation, a distributed acoustic detection network may be used to track the occupancy of areas of the store both in real-time and historically. This is possible because shoppers tend to generate noise, e.g., when they talk, push a cart, place items in a cart or basket, etc. Therefore, the server may use detected noise levels from the acoustic sensor network to determine which areas of the store are currently occupied. Further, the server may use the frequency at which noise is detected in an area of the store over time to track the amount of traffic through that area. In this implementation, the controller 120, 220 may send a message to the server when the noise level goes above a programmed level that is set high enough to distinguish shopper-generated noise from background noise. The distributed acoustic sensor network may be used separately or in combination with the distributed motion sensor network to track occupancy.

In another implementation, the sensor 140 or sensor suite 240 may comprise, for example, a shock sensor. In this implementation, the shock sensor may be used to detect shock to a wireless device, e.g., caused by tampering, dropping, bumping, etc, of the individual device. The shock sensor may also be used to detect shock to an object on which a wireless device is attached. For example, if the wireless device is attached to a shelf, the shock sensor may be used to detect shock to the shelf, e.g., caused by the shelf collapsing, a cart or shopper bumping the shelf, etc. In this implementation, if shock above a programmed level is detected, the controller 120, 220 may send a message to the server alerting it to this fact.

In another implementation, the sensor 140 or sensor suite 240 may comprise, for example, a tilt sensor. In this implementation, the tilt sensor may be used to detect when a wireless device is tilted at an angle. If the wireless device is tilted, the controller 120, 220 may send a message to the server altering it to this fact. The server may then send a message to a store employee so that the employee can straightened the wireless device.

1. A wireless device comprising:
a display;
a wireless transceiver;
a sensor;
a light emitting diode (LED); and
a controller in communication with the display, wireless transceiver, LED, and sensor.

2. The wireless device of claim 1, wherein the controller is configured to read sensor data from the sensor and to change a message on the display based on the read sensor data.

3. The wireless device of claim 1, wherein the controller is configured to read sensor data from the sensor and to initiate wireless communication with a remote system via the wireless transceiver based on the read sensor data.

4. The wireless device of claim 3, wherein the controller is configured to initiate the wireless communication when the read sensor data goes outside a predetermined range.

5. The wireless device of claim 3, wherein the controller is configured to initiate the wireless communication when the read sensor data goes above or below a predetermined value.

6. The wireless device of claim 1, wherein the controller is configured to read data from the sensor and to control operation of the LED based on the read sensor data.

7. The wireless device of claim 1, further including a mounting mechanism for mounting the wireless device on a shelf.

8. The wireless device of claim 1, wherein the controller is configured to receive a price of an item from a remote system via the wireless transceiver, and to display the received price on the display.

9. The wireless device of claim 1, wherein the sensor comprises an acoustic sensor.

10. The wireless device of claim 1, wherein the sensor comprises a chemical sensor.

11. The wireless device of claim 1, wherein the sensor comprises a light sensor.

12. The wireless device of claim 1, wherein the sensor comprises a temperature sensor.

13. The wireless device of claim 1, wherein the sensor comprises a motion detector.

14. The wireless device of claim 1, wherein the sensor comprises a shock sensor.

15. The wireless device of claim 1, wherein the sensor comprises a tilt sensor.

16. The wireless device of claim 1, wherein the sensor comprises a tamper sensor.

17. The wireless device of claim 1, further comprising a plurality of sensors, wherein the plurality of sensors comprise two or more sensors selected from the group consisting of: an acoustic sensor, a chemical sensor, a light sensor, a temperature sensor, a motion detector, a shock detector, a tilt sensor, and a tamper sensor.

18. The wireless device of claim 17, wherein the controller is configured to read sensor data from any one of the plurality of sensors, and to change a message on the display based on the read sensor data.

19. The wireless device of claim 17, wherein the controller is configured to read sensor data from any one of the plurality of sensors, and to initiate wireless communication with a remote system via the wireless transceiver based on the read sensor data.

20. The wireless device of claim 17, wherein the controller is configured to read sensor data from any one of the plurality of sensors, and to control operation of the LED based on the read sensor data.

21. A distributed wireless network comprising:
a plurality of wireless devices, wherein each wireless device comprises:
a display;
a sensor;
a light emitting diode (LED);
a wireless transceiver; and
a controller in communication with the display, sensor, LED, and wireless transceiver;
at least one hand-held device capable of communicating with any one of the wireless device via the corresponding wireless transceiver;
a plurality of access points, wherein each access point is configured to communicate with one or more of the wireless devices via the corresponding wireless transceivers and the hand-held device; and
a server coupled to the access points.

22. The network of claim 21, wherein the wireless devices are located at different locations within a store.

23. The network of claim 22, wherein the server is configured to send product prices to the wireless devices via the access points.

24. The network of claim 22, wherein the controller of each wireless device is configured to read sensor data from the corresponding sensor and to initiate wireless communication with the server via one of the access points via the corresponding wireless transceiver based on the read sensor data.

25. The network of claim 22, wherein the controller of each wireless device is configured to read sensor data from the corresponding sensor and to initiate the wireless communication with the server via one of the access points via the corresponding wireless transceiver when the read sensor data goes outside a predetermined range, and to send an alert message to the server alerting the server of the sensor data outside of the predetermined range.

26. The network of claim 25, wherein the server is configured to send a message to a store employee upon receiving the alert message from one of the wireless devices.

27. The network of claim 22, wherein one or more of the wireless devices are mounted on shelves within the store.

28. The network of claim 22, wherein the sensor of each wireless devices comprises an acoustic sensor, a chemical sensor, a light sensor, a temperature sensor, a motion detector, a shock sensor, a tilt sensor, or a tamper sensor.
